(19) United States
(12) Patent Application Publication
(10) Pub. No.: US 2014/0226358 A1
(43) Pub. Date: Aug. 14, 2014

(54) STOLLER HEADLIGHT

(71) Applicant: Brian Lewis Nielson, New York, NY (US)

(72) Inventor: Brian Lewis Nielson, New York, NY (US)

(21) Appl. No.: 13/765,762

(22) Filed: Feb. 13, 2013

(51) Int. Cl. B62B 9/00; F21V 19/00

(52) U.S. Cl. CPC B62B 9/005; F21V 19/00
USPC 362/543

(57) ABSTRACT

A stroller light or headlight that attaches to the front of the stroller for lighting the path ahead of the stroller and for making the stroller more visible to people at night.

### BACKGROUND OF THE INVENTION

1. Field of the Invention

The present invention generally relates to a method, system, and apparatus for lighting a stroller or baby carriage, and more particularly to a light that attaches to a stroller, for example, a headlight that attaches to the front of the stroller for lighting the path ahead of the stroller and for making the stroller more visible to people at night.

2. Related Art

The inventor of the present application is a father. In the course of pushing his children in a stroller he discovered that conventional strollers pose potentially dangerous situations, particularly at dusk/dawn and during the evening, in a number of respects, as explained herein.

### SUMMARY OF THE INVENTION

The dangerous situations discovered by the inventor of the present application are as follows.

First, it can be difficult for others at night (e.g., bikers and motorists) to see a stroller or to see a parent pushing his or her child in a stroller, particularly since most strollers are black. This creates a potentially perilous situation.

Second, it can be difficult for someone pushing the stroller at night to see what is in front of them. This includes objects on the sidewalk or other dangerous conditions. Conventional strollers have no headlights attached to them to enable the person pushing the stroller to see in front of the stroller.

The foregoing and other problems are overcome by the stroller light or headlight of the present invention and the methods, apparatuses, and systems disclosed herein. The stroller light disclosed herein can attach to suitable areas of a stroller, e.g., to a pole or post of the stroller.

The present invention according to one aspect provides a stroller headlight, comprising a body having a nub or hook protruding from the bottom of the body and a flexible strap protruding from the back of the body. The strap has a mating portion towards an end of the strap which is adapted to surround a stroller post and mate with the nub or hook to secure the body to the stroller post.

The nub or hook can be made of a suitably hard material such as metal or plastic such that it can mate with the mating portion of the strap, and the strap can be made of a suitably flexible material that also has a sufficient measure of strength to mate with the nub or hook and hold the stroller light in place, such as flexible rubber. Of course, any other suitable material will do.

At least one front LED (and preferably five) is arranged on the front of the body, and at least one side LED (and preferably two) is arranged on each side of the body. A button or switch enables a user to control the front and side LEDs.

By virtue of the features of the present invention, various dangers of pushing a stroller at dawn/dusk or during the evening can be ameliorated, and, moreover, a person pushing a stroller can better see what is in front of them.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will be more readily understood from a detailed description of the exemplary embodiments taken in conjunction with the following figures:

FIG. 1A illustrates two stroller lights attached to the front of a stroller according to an embodiment of the present invention.

FIG. 1B illustrates a close-up view of two stroller lights attached to the front of a stroller according to an embodiment of the present invention.

FIG. 2 illustrates a close-up side view of a stroller light attached to a post of a stroller according to an embodiment of the present invention.

FIG. 3 illustrates a side view of the stroller light according to an embodiment of the present invention.

FIG. 4 is a diagram illustrating a pair of stroller lights attached to a post of a stroller according to another embodiment of the present invention.

The invention will next be described in connection with certain exemplary embodiments; however, it should be clear to those skilled in the art that various modifications, additions, and subtractions can be made without departing from the spirit or scope of the claims.

### DETAILED DESCRIPTION OF THE PREFERRED EMBODIMENTS

As noted above, the present invention is directed to a method, system, and apparatus for lighting a baby carriage or stroller, and more particularly to a light that attaches to a stroller, for example a headlight that attaches to the front of the stroller for lighting the path ahead of the stroller and for making the stroller more visible to people at night. The light could also attach to other areas of the stroller, e.g., the side or back.

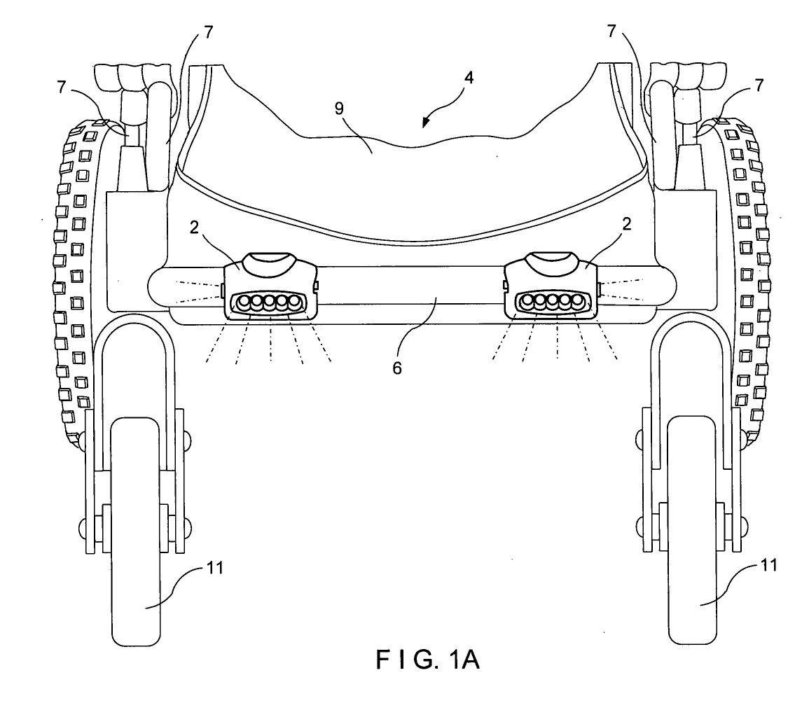

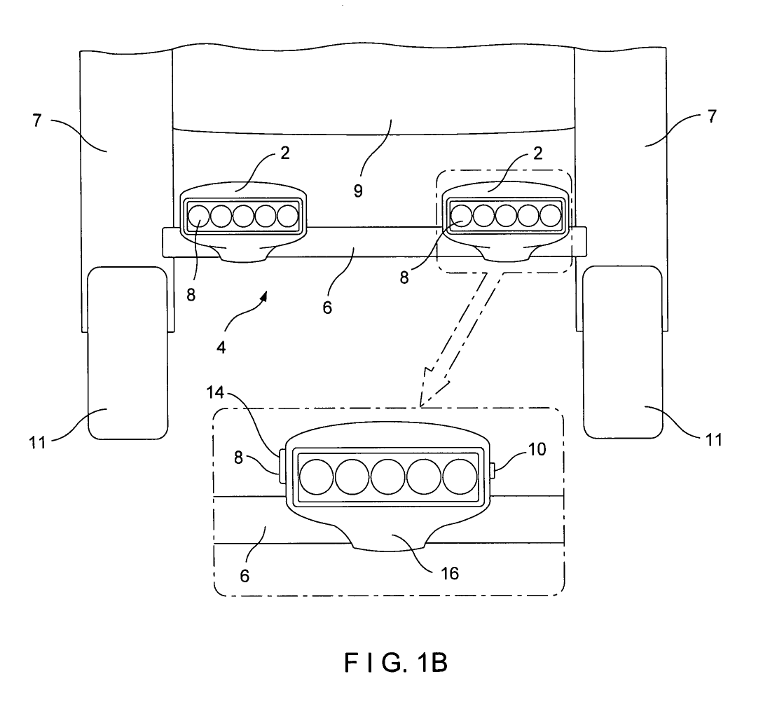

FIG. 1A illustrates an embodiment of the present invention. Reference numeral 2 designates a stroller light. FIG. 1A illustrates two stroller lights 2 attached to the front of a stroller 4. The stroller 4 comprises a frame made up of a plurality of posts or support members (see reference numeral 6 and the various reference numerals 7), a housing 9 attached to the frame and adapted to hold a baby, a plurality of wheels 11 attached to the frame and adapted to enable the stroller to move or be pushed, etc.

The stroller lights 2 attached to the front of the stroller 4 emit light in a forward direction to enable the person pushing the stroller 4 to see in front of the stroller 4. This also enables others to see the stroller 4 from a distance.

Each stroller light 2 is attached to a stroller post 6 for securing the stroller light 2 to the stroller 4. Of course, while the stroller lights 2 are shown in FIG. 1 attached to the front of the stroller and to front stroller post 6, any stroller light 2 could just as well be attached to the side or the back of the stroller 4, indeed, to a side or back post of the stroller 4, or to any suitable location. Moreover, any number of stroller lights 2 could be employed. Furthermore, the stroller light 2 is shown here as applied to strollers or baby carriages, but could just as well be secured to handheld baby seats as well, infant car seats, ride-on toys, push cart, pram, or to any other suitable apparatus.

FIG. 1B illustrates a close-up view of two stroller lights 2 attached to the front of a stroller according to an embodiment of the present invention. Also illustrated in FIG. 1B is a blow-up image of the stroller light 2 on the right, showing more detail.

In FIG. 1B, stroller headlights 2 are each attached to stroller post 6. They could also be attached to posts 7 or to any suitable part of the stroller housing 9. The stroller lights 2 each have LED bulbs 8 (here, five bulbs to each light but of course that number could vary) which emit light. In the blow-up image, more detail is shown, including power button 14 and side LED lights 10 (e.g., two side LED lights but any suitable number will do). Below various embodiments for attaching the stroller light 2 around the stroller post 6 will be explained. This embodiment has a rubber strap 16 as further described below.

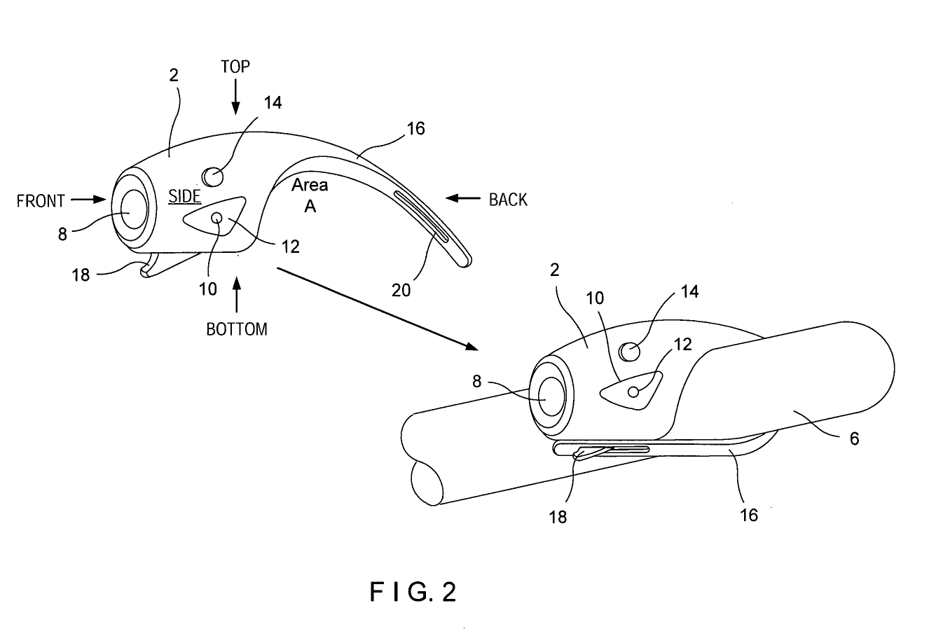

FIG. 2 illustrates a close-up side view of how a stroller light 2 attaches to a stroller post 6. Specifically, FIG. 2 shows a stroller light 2 on the left unattached to the post 6, and then on the right the stroller light 2 now attached to the post 6. The stroller light 2 has light emitting diode or LED bulb 8 for emitting light. Only one LED bulb is shown in the figure, but of course any suitable number of LED bulbs (e.g., five) could be employed. Other types of lights could be employed as well, and the LED bulbs can emit light of any color (e.g., red, blue, white, green, yellow, purple, etc.).

Stroller light 2 also has an LED 10 on each side (only one side LED 10 is shown in the figure) which can light a larger side safety light area 12. Together these can emit blinking lights or flashing lights or constant light of any color (e.g., red, blue, white, green, yellow, purple, etc.) and at any timing pattern or mode. The user can manipulate these lights (turn them off and on or switch timing patterns) using button 14 (which may also be a switch or any suitable device).

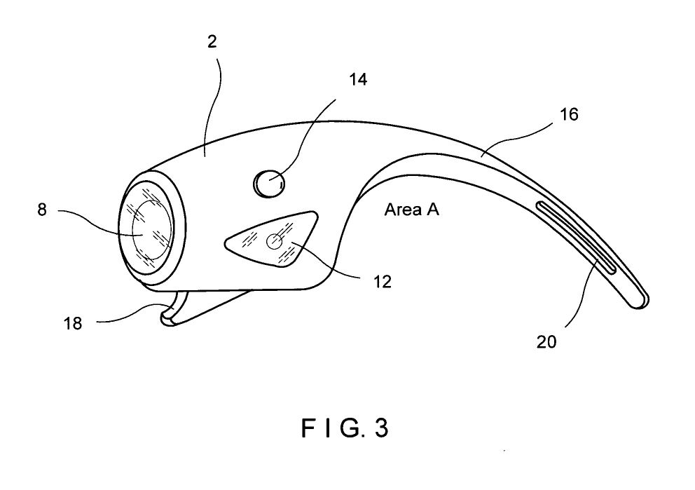

It will now be explained in conjunction with the side view of FIG. 3 how the stroller light 2 engages with the stroller post 6 in this embodiment. As can be seen, the stroller light 2 has a strap or hand 16 made of flexible rubber (or any other suitable flexible material) which can grab or wrap around the stroller post 6. Area A shows where the stroller post 6 will be (into the page). Once wrapped around the stroller post 6, the mating portion 20 of the strap or hand 16 mates with nub or hook 18 to secure the stroller light 2 to the stroller post 6. See FIG. 2 again, which shows stroller light 2 secured to stroller post 6 via the strap or hand 16 which grips the stroller post 6 and mates with nub or hook 18. It is noted that the strap or hand 16 can rotate around the stroller post 360 degrees to allow for both horizontal and vertical mounting to the stroller post 6. Nub or hook 18 may be made of plastic, metal, or any suitable material that is hard enough to secure or hold the mating with the hand 16. The strap 16 and nub/hook 18 may together to be considered a mating unit that mates the stroller light 2 to the stroller post 6. FIG. 2 also indicates the front, top, bottom, back, and one side of the stroller light 2. (Of course, there are two sides of the stroller light 2.) Reference numeral 2 in FIGS. 1-3 generally points to the body of the stroller light.

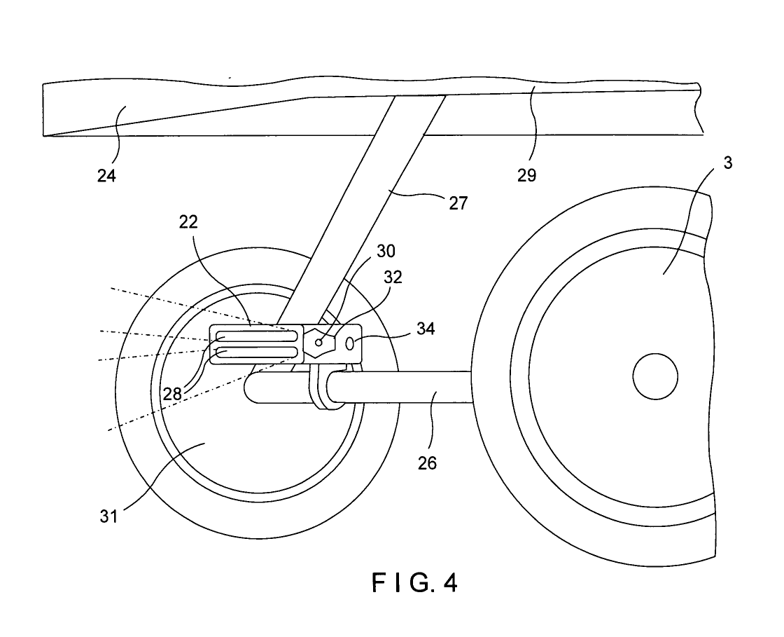

FIG. 4 is a diagram illustrating a pair of stroller lights 22 attached to a post 26 of a stroller 24 according to another embodiment of the present invention. The stroller 24 comprises a frame made up of a plurality of posts or support members such as 26, 27, a housing 29 attached to the frame and adapted to hold one or more babies, a plurality of wheels 31 attached to the frame and adapted to enable the stroller to move or be pushed, etc. In FIG. 4, a plurality of “rays of light” emanating from the stroller lights 22 are also shown as straight lines, unlabeled. Reference numeral 22 in FIG. 4 generally points to the body of the stroller light.

In this embodiment of FIG. 4, each stroller light 22 comprises long LED lights 28. The figure shows two long LED lights 28 (any color) but of course any suitable number could be arranged. The stroller lights 22 shown in FIG. 4 each have side LED lights 30 (any color) which can light the larger side safety light area 32 (any color, preferably red). Button 34 enables the user to manipulate these lights (turn them off and on or switch timing patterns). Button 34 may also be a switch or any suitable device.

In the embodiment shown in FIG. 4 the hand 36 is designed differently from the embodiment of FIG. 2. The hand 36 is not as flexible, and so instead of gripping the stroller post and mating with a nub as in the previous embodiment, it simply snaps onto or around the stroller post 26. In this embodiment, the stroller light 22 is disposed above the hand 36. Note that the hand 36 can rotate 360 degrees to allow for both horizontal and vertical mounting to the stroller post 26. Any suitable material for the hand (e.g., plastic) will do. The hand 36 may be considered a mating unit to mate the stroller light 22 to the stroller post 26. The hand can be made adjustable in size as well such that it fits around posts of various circumference.

### Features

The following are features of the stroller light of the present invention.

The stroller light is easy to attach and detach at any position on the stroller post. It is rotatable and provides for very quick installation, typically of no more than a few seconds. Its unique rubber strap or “hand” firmly holds to a stroller post without scratching the post. Its light or LED signal is visible for up to approximately one mile or more. It is weatherproof, and has three LED functions (Random Flash, Steady Flash, Steady Beam). It has a high impact rubber casing that surrounds it for protection. It fits most strollers, infant car seats, and ride-on-toys.

A challenge overcome by the inventor was to attach the stroller light to the stroller so that the stroller light is securely attached to the stroller and in a convenient and useful location, and also so that the user can have multiple attachment locations to choose from depending on which is more useful and convenient. With the attachment methods of the present invention, a stroller can be fitted with a stroller light even after the stroller is manufactured.

Functions

The Operation LED life is up to approximately 100,000 hours. It can be designed in multiple colors (e.g., black, blue, red, green, yellow, purple, etc). It has a plurality (e.g., 5) of bright LED bulbs (e.g., white), and a plurality (e.g., 2) of side lights (e.g., red). It can be powered very easily by, e.g., three AAA batteries. A preferred size of the stroller light is approximately 10 cm×3.3 cm, but of course any other suitable size works as well.

### Specifications:

These are of course just examples and the present invention is not limited thereto:
weight: approx. 3 oz.(including batteries);
light output: approx. 65 Lumens;
fits any tubing from, e.g., 20-36 mm, and can fit other size tubings as well.
highly durable;
water proof to protect from rain;

By virtue of the features of the present invention, it can be made easier for people at night (e.g., pedestrians, bikers, skateboarders, rollerbladers, motorists) to see a parent pushing his or her child in a stroller. Moreover, the dangerous situation in which it is difficult for someone pushing the stroller at dusk or at night to see what is in front of them can be ameliorated.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above-described exemplary embodiments, but should be defined only in accordance with the following claims and their equivalents.

In addition, it should be understood that the Figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

What is claimed is:

1. A stroller light, comprising:
a body;
a hook protruding from one area of the body;
a strap protruding from another area of the body and adapted to wrap around a stroller post, wherein the strap has a mating portion towards an end of the strap which is adapted mate with the hook to secure the body to the stroller post; and
at least one LED on the body.

2. The stroller light of claim 1, further comprising at least one side LED arranged on each side of the body, and a button for controlling the LEDs

3. The stroller light of claim 1, wherein the strap is composed of flexible rubber.

4. The stroller light of claim 1, wherein the hook is composed of hard plastic.

5. The stroller light of claim 1, wherein the mating portion of the strap has a hole which the hook fits into such that the strap and the hook are mated.

6. The stroller light of claim 1, wherein the button enables switching of a mode of the at least one LED between a random flashing mode, a steady flashing mode, and a steady beam mode.

7. A stroller light for attaching to a stroller, comprising:
a body, having a hand protruding from the body, the hand being adapted to snap around a stroller post to secure the body to the post;
at least one LED arranged on the body; and
a button for controlling the at least one LED.

8. The stroller light of claim 7, wherein the hand is composed of plastic.

9. The stroller light of claim 7, wherein the at least one LED is arranged on a front of the body, and at least one side LED is arranged on a side of the body.

10. The stroller light of claim 9, wherein the at least one LED arranged on the front of the body emits a white light and the at least one side LED emits a light of a different color.

11. A stroller, comprising:
a frame having a plurality of posts;
a housing attached to the frame and adapted to hold a baby;
a plurality of wheels attached to the frame and adapted to enable the stroller to move; and
a stroller light attached to a post, the stroller light including:
a body;
a hook protruding from one area of the body;
a strap protruding from another area of the body and adapted to wrap around a post, wherein the strap has a mating portion towards an end of the strap which is adapted to mate with the hook to secure the body to the post,
at least one LED arranged on the body.

12. The stroller of claim 11, wherein the post that the body is secured to is disposed between two wheels.

13. The stroller of claim 11, wherein the strap of the stroller light is composed of flexible rubber.

14. The stroller light of claim 11, wherein the hook of the stroller light is composed of hard plastic.

15. The stroller of claim 11, wherein the mating portion of the strap of the stroller light has a hole which the hook fits into such that the strap and the hook are mated.

16. The stroller of claim 11, wherein the at least one LED is arranged on the front of the body, and further comprising at least one side LED arranged on each side of the body and a button or switch for controlling the LEDs.

17. A method for lighting a stroller comprised of a frame having a plurality of posts and housing attached to the frame and adapted to hold a baby, the method comprising:
attaching the stroller light of claim 1 to a front post of the stroller.

18. A stroller light for attaching to a stroller, comprising:
a body, having a mating unit that is adapted to mate with a stroller post to secure the body to the stroller post;
at least one LED arranged on the body; and
a button for controlling the at least one LED.

19. The stroller light of claim 18, further comprising at least one side LED arranged on each side of the body, and a button for controlling the LEDs

20. The stroller light of claim 19, wherein the button enables switching of a mode of the at least one LED between a random flashing mode, a steady flashing mode, and a steady beam mode.
